(19) United States
(12) Patent Application Publication
(10) Pub. No.: US 2007/0253011 A1
(43) Pub. Date: Nov. 1, 2007

(54) PRINTING SYSTEM AND METHOD

(75) Inventor: John Wang, Taipei (TW)

Correspondence Address: QUINTERO LAW OFFICE, PC, 2210 MAIN STREET, SUITE 200, SANTA MONICA, CA, 90405, US

(73) Assignee: LITE-ON TECHNOLOGY CORPORATION, TAIPEI (TW)

(21) Appl. No.: 11/739,649

(22) Filed: Apr. 24, 2007

(30) Foreign Application Priority Data
Apr. 29, 2006 (CN) CN200610078984.0

(51) Int. Cl. G06F 3/12

(52) U.S. Cl. 358/1.13

(57) ABSTRACT

A printing method is disclosed. A document including at least one type of object is provided. An object selection menu is provided for designating at least one type of object as a print target. According to the object selection menu, the object within the document corresponding to the print target is processed, and a print image is generated accordingly. A print output is generated according to the print image.

### BACKGROUND

The invention relates to a printer, and in particular to system and method capable of printing selected types of objects within a document.

Conventionally, when a document is printed, the print output thereof comprises all the objects (for example, text, image, and graphics objects) originally comprised in the document. The conventional method does not allow a user to select particular types of objects from the document and print the selected types of objects, exclusive of the un-selected objects.

For example, a document comprises text objects, as well as large amount of image and graphics objects. In response to a print command, all the text, image, and graphics objects are printed. For example, exclusively printing only text objects is not possible. The conventional method is not capable of printing out only selected object types within a document, exclusive of the un-selected object types. Additional processing resources and cost are increased (for example, paper and printing ink) are consumed in the printing process, because both the required (selected) and un-required (un-selected) object types are printed.

Thus, a method enabling for printing only selected object types is desirable.

### SUMMARY

A printing method is provided. A document, stored in electronic form, is provided, wherein the document comprises at least one object type. An object selection menu is provided for designating at least one object type as a print target. According to the object selection menu, the object within the document corresponding to the print target is processed, and a print image is generated accordingly. A print output is generated according to the print image.

An apparatus for processing print objects is provided. An interface receives a document comprising at least a text object, a graphics object, or an image object. An object selection unit provides an object selection menu for selecting at least the text, graphic, or image objects as a print target. A processor processes, according to the object selection menu, the object within the document corresponding to the print target. A print image generation unit generates a print image accordingly.

### DESCRIPTION OF THE DRAWINGS

The invention can be more fully understood by reading the subsequent detailed description and examples with references made to the accompanying drawings, wherein:

FIG. 1 is a schematic view of an embodiment of a system;

FIG. 2 shows a schematic view of an embodiment of an apparatus for processing print objects;

FIG. 3 is a flow chart of an embodiment of a printing method; and

FIG. 4 illustrates a screen display of an embodiment of an object selection menu.

### DETAILED DESCRIPTION

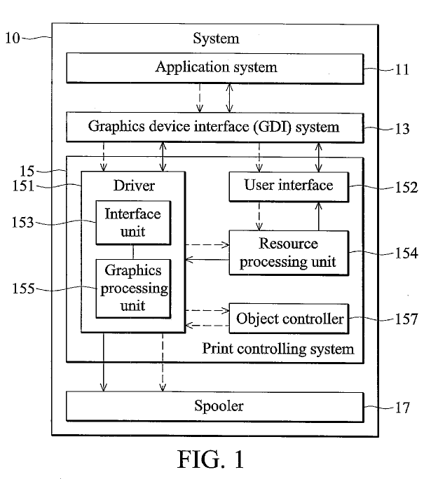

The invention will now be described with reference to FIGS. 1 through 4.

In the following detailed description, reference is made to the accompanying drawings which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures corresponds to the Figure number, with the exception that the same reference number is used throughout to refer to an identical component which appears in multiple figures.

FIG. 1 is a schematic view of an embodiment of a system. In FIG. 1, data exchanges occur between components of system 10, wherein a solid line represents transfer of data, and a dotted line represents transfer of a command. System 10 comprises an application system 11, a graphics device interface (GDI) system 13, a print controlling system 15, and a spooler 17. In some embodiments of a system, a printing process executed in system 10 is performed through application system 11 by calling a Win32 GDI function provided by Microsoft Corporation. According to the printing process, a print image is rendered corresponding to each page of a document to be printed stored in electronic form. According to the rendering process, a GDI drawing engine calls a proper print controlling system 15 to execute the rendering process. The application system 11 can comprise any application program, such as a text processing program or a web page browser.

The GDI system 13 is one of the three core components or “subsystems” of Microsoft Windows. The GDI system 13 is a Microsoft Windows standard for representing graphics objects and transmitting them to output devices such as monitors and printers.

The print controlling system 15 controls a printer (not shown) to perform a printing process. A document to be printed by the printer can comprise at a text object, an image object, or a graphics object. The text object comprises pure text; the graphics object comprises vector graphics; and the image object comprises a bitmap image.

The print controlling system 15 assists GDI in performing the printing process by providing rendering functions for printers not supporting GDI. In addition, the print controlling system 15 transmits data generated by the rendering process to the spooler 17. The print controlling system 15 also provides a user interface for inputting printer setup options, such as paper feed/output selection, number of copies, image/text quality and page orientation of a printer and a print job thereof.

The print controlling system 15 comprises a driver 151, a user interface 152, a resource processing unit 154, and an object controller 157. A driver program can implement the driver 151. The driver program transforms a document to be printed to a data format that can be handled by the printer. The driver 151 comprises an interface unit 153 and a graphics processing unit 155. The interface unit 153 can be implemented by a printer interface dynamic linking library (DLL), providing an interface for the driver 151 to inform the print controlling system 15 of an event pertaining to a print job. The graphics processing unit 155 can be implemented by a printer graphical processing DLL, assisting GDI in performing a print job, and transmitting data flow generated thereby to the spooler 17. The printer graphical processing DLL implementing the graphics processing unit 155 comprises various functions to perform print jobs for text objects, image objects, and graphics object, respectively. A DrvTextOut( ) function is called to process the text object to include the text object in the print image. A DrvStrchBlt( ) function, DrvBitBlt( ) function, and a DrvCopyBits( ) function are called to process the image object to include the image object in the print image. A DrvStrokePath( ) function, DrvFillPath( ) function, and DrvStrokeAndFillPath( ) function are called to process the graphics object to include the graphics object in the print image. The object controller 157 selects, according to a user command, certain types of objects from a given document as a print target for a print job. The user interface 152 provides an operating interface, enabling the user to configure print job options, such as paper size and number of copies. The resource processing unit 154 employs various resources, such as multilingual support information, menu information, string information, and image information.

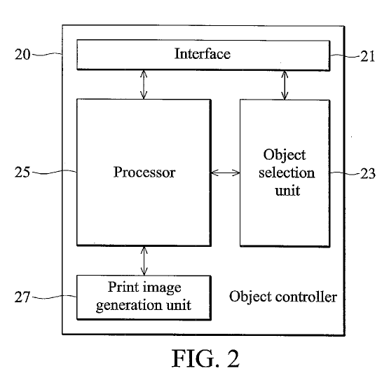

Referring to FIG. 2, an object controller 20 comprises an interface 21, an object selection unit 23, a processor 25, and a print image generation unit 27. The interface 21 receives a document stored in electronic form, wherein the document comprises at least one of the following object types: a text object, a graphics object, or an image object. The object selection unit 23 provides an object selection menu for designating at least the text, graphic, or image objects as a print target. The processor 25 processes, according to the object selection menu, the object within the document corresponding to the print target. The print image generation unit 27 calls appropriate functions for processing the objects selected as the print target to generate a print image accordingly. In addition, the print image generation unit 27 transfers the print image to a spooler.

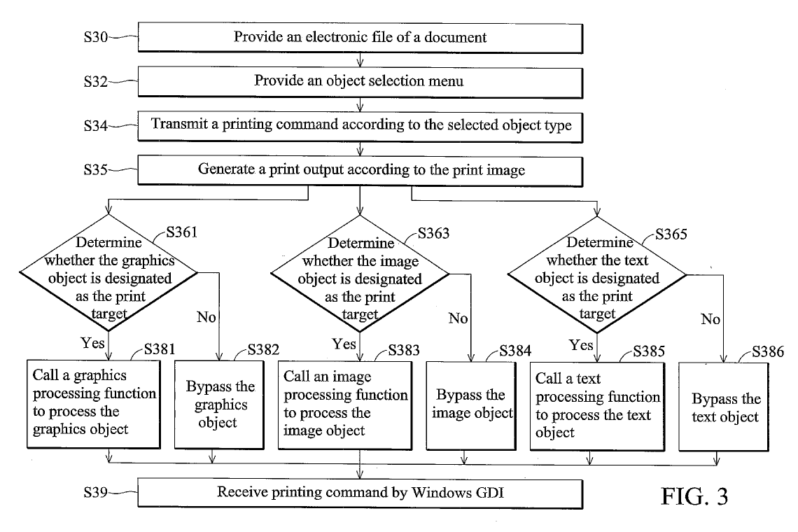

FIG. 3 is a flowchart of an embodiment of a printing method. Referring to FIG. 3, an electronic file of a document is first provided (step S30). The file can be a word document file, web page file, or other file type. The file comprises at least one object type. Here, the file comprises at least one of the following object types: a text object, a graphics object, and an image object. The text object comprises pure text; the graphics object comprises vector graphics; and the image object comprises a bitmap image.

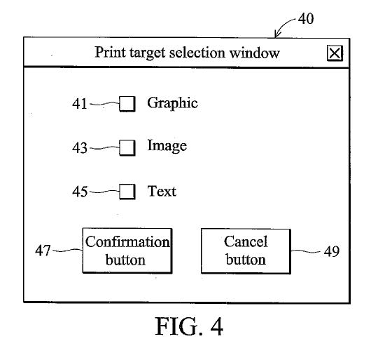

An object selection menu is provided for designating at least one object type as a print target (step S32). The object selection menu can be presented as FIG. 4. As shown in FIG. 4, the “print target selection window” 40 displays 3 options: graphic, image, and text. Each of the options is accompanied by a check box. The graphics object is selected as the print target when the check box 41 is ticked. The image object is selected as the print target when the check box 43 is ticked. The text object is selected as the print target when the check box 45 is ticked. The confirmation button 47 is clicked after the check boxes are ticked, a list of selected object types is generated, and the method proceeds to step S34. If the cancel button 49 is clicked after the check boxes are ticked, the check boxes are cleared, and the method returns to step S30.

An application program transmits a printing command according to the selected object type (print target) (step S34). The printing command is received by Windows GDI (step S35).

In step S361, it is determined whether the graphics object is designated as the print target, and if so, the method proceeds to step S381, otherwise, to step S382. In step S381, a graphics processing function is called to process the graphics object to include the graphics object in the print image. In step S382, the graphics object is bypassed and the graphics object is not included in the print image. The graphic processing function called to process the graphics object can be a DrvStrokePath( ) function, DrvFillPath( ) function, and DrvStrokeAndFillPath( ) function.

In step S363, it is determined whether the image object is designated as the print target, and if so, the method proceeds to step S383, otherwise, to step S384. In step S383, if the image object is designated as the print target, an image processing function is called to process the image object to include the image object in the print image. In step s384, if the image object is not designated as the print target, the image object is bypassed and is not included in the print image. The image processing function called to process the image object can be a DrvStrchBlt( ) function, DrvBitBlt( ) function, and a DrvCopyBits( ) function.

In step S365, it is determined whether the text object is designated as the print target, and if so, the method proceeds to step S385, otherwise, to step S386. In step S385, if the text object is designated as the print target, a text processing function is called to process the text object to include the text object into the print image. In step S386, if text object is not designated as the print target, the text object is bypassed and is not included in the print image. The text processing function called to process the text object can be the DrvTextOut( ) function.

In step S39, a print output is generated according to the generated print image.

While the invention has been described by way of example and in terms of several embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A printing method, comprising:
providing a document, stored in electronic form, comprising at least one object type;
providing an object selection menu for designating at least one of the object types as a print target;
processing, according to the object selection menu, the objects within the document corresponding to the print target, and generating a print image accordingly; and
generating a print output according to the print image.

2. The method of claim 1, wherein the document comprises at least a text object, a graphics object, or an image object.

3. The method of claim 2, further comprising:
determining whether the text object is designated as the print target;
if the text object is designated as the print target, calling a text processing function to process the text object to include the text object in the print image; and
if text object is not designated as the print target, bypassing the text object and not including the text object in the print image.

4. The method of claim 3, further calling a DrvTextOut( ) function to process the text object to include the text object in the print image.

5. The method of claim 2, further comprising:
determining whether the image object is designated as the print target;
if the image object is designated as the print target, calling an image processing function to process the image object to include the image object in the print image; and
if the image object is not designated as the print target, bypassing the image object and not including the image object in the print image.

6. The method of claim 5, further calling a DrvStrchBlt( ) function, DrvBitBlt( ) function, and a DrvCopyBits( ) function to process the image object to include the image object in the print image.

7. The method of claim 2, further comprising:
determining whether the graphics object is designated as the print target;
if the graphics object is designated as the print target, calling a graphic processing function to process the graphics object to include the graphics object in the print image; and
if the graphics object is not designated as the print target, bypassing the graphics object and not including the graphics object in the print image.

8. The method of claim 7, further calling a DrvStrokePath( ) function, DrvFillPath( ) function, and DrvStrokeAndFillPath( ) function to process the graphics object to include the graphics object in the print image.

9. An apparatus for processing print objects, comprising:
an interface, receiving a document, stored in electronic form, comprising at least a text object, a graphics object, or an image object;
an object selection unit, providing an object selection menu for designating at least one of the text, graphic, and image objects as a print target;
a processor processing, according to the object selection menu, the object within the document corresponding to the print target; and
a print image generation unit, generating a print image accordingly.

10. The apparatus of claim 9, wherein the processor further performs steps of:
determining whether the text object is designated as the print target;
if the text object is designated as the print target, calling a DrvTextOut( ) function to process the text object to include the text object in the print image; and
if text object is not designated as the print target, bypassing the text object and not including the text object in the print image.

11. The apparatus of claim 9, wherein the processor further performs steps of:
determining whether the image object is designated as the print target;
if the image object is designated as the print target, calling a DrvStrchBlt( ) function, DrvBitBlt( ) function, and a DrvCopyBits ( ) function to process the image object to include the image object in the print image; and
if the image object is not designated as the print target, bypassing the image object and not including the image object in the print image.

12. The apparatus of claim 9, wherein the processor further performs steps of:
determining whether the graphics object is designated as the print target;
if the graphics object is designated as the print target, calling a DrvStrokePath( ) function, DrvFillPath( ) function, and DrvStrokeAndFillPath( ) function to process the graphics object to include the graphics object in the print image; and
if the graphics object is not designated as the print target, bypassing the graphics object and not including the graphics object in the print image.
